(19) United States
(12) Patent Application Publication
(10) Pub. No.: US 2012/0057448 A1
(43) Pub. Date: Mar. 8, 2012

(54) RECORDING METHOD, RECORDING DEVICE AND INFORMATION RECORDING MEDIUM

(75) Inventors: Kiyotaka Ito, Hyogo (JP); Yasumori Hino, Nara (JP); Naoyasu Miyagawa, Hyogo (JP); Atsushi Nakamura, Osaka (JP)

(73) Assignee: PANASONIC CORPORATION, Osaka (JP)

(21) Appl. No.: 13/318,722

(22) PCT Filed: Mar. 7, 2011
(86) PCT No.: PCT/JP2011/001335

§ 371 Date: Nov. 3, 2011

(30) Foreign Application Priority Data
Mar. 8, 2010 (JP) 2010-050001

(51) Int. Cl. G11B 7/125; G11B 7/139

(52) U.S. Cl. 369/112.23; G9B/7.127; G9B/7.102

(57) ABSTRACT

A writing method according to the present invention is a method for writing a data sequence as a combination of marks and spaces on an information recording medium by condensing a laser beam through a lens. The writing method is characterized in that a cooling pulse for recording a mark that is even shorter than the limit of optical resolution of the laser beam and another cooling pulse for recording a mark that is still longer than the limit of the optical resolution of the laser beam are applied under mutually different conditions.

### TECHNICAL FIELD

The present invention relates to a method and device for writing information on an information recording medium and also relates to an information recording medium itself.

### BACKGROUND ART

A device for reading and writing information from/on an information recording medium is used extensively as a means for storing a huge amount of information.

An optical disc is well known as a typical information recording medium.

Examples of optical discs include CD-R/RW, DVD±R/RW, DVD-RAM, Blu-ray Disc-R/RE (which will be abbreviated herein as “BD-R/RE”), and HD DVD-R/RW/RAM.

To write information on an optical disc, the optical disc needs to be rotated and have its recording film irradiated with a converged laser beam.

In this case, by irradiating the recording film with a high-energy light beam, thermal energy will be produced and change the structure of the recording film, thereby recording marks on the film. And each of those recorded marks and spaces between the recorded marks is regarded as representing either a logical zero state or a logical one state, thereby storing digital information there.

Or information may also be stored on an optical disc by regarding the boundary between each recorded mark and the space as representing zero or one.

A write pulse applied to record a single mark has multiple parameters, each of which varies according to the length of the mark to record and the writing speed adopted.

In the following description, those parameters of a write pulse will be referred to herein as a “write strategy” (which will be sometimes simply referred to herein as “WS”).

A write pulse in the simplest form consists of a single rectangular pulse.

However, if such a single rectangular pulse were applied to record a long mark, of which the length is several times as long as T (that is one channel clock period), then the resultant recorded mark would be a deformed one with a thin front edge and a thick rear edge.

As described above, a mark is recorded on a recording film by changing the structure of the recording film with the thermal energy produced. That is why if the write operation has just begun, the temperature of the recording film is still too low to change the structure of the recording film easily. As a result, the recorded mark will be a thin one.

On the other hand, when the write operation is going to end, the thermal energy that has been produced will have propagated and will have been accumulated over the optical disc. That is why the thermal energy stored there will be so much as to change the structure of the recording film easily. As a result, the recorded mark will be a thick one.

And once a recorded mark gets deformed in this manner, the waveform of the read signal will also be deformed and errors will increase.

On top of that, if too much heat were stored, the recording film should be more likely to deteriorate and affect the storage quality as well.

Thus, to overcome such problems, there are various modified types of write pulses, which include a multi-pulse type write pulse that consists of multiple short pulses to prevent too much thermal energy from being stored by the end of a write operation, a castle type write pulse that has an interval with a lower laser power level between two pulses, and an L-shaped write pulse, which is obtained by removing the last pulse from the castle type write pulse.

For example, Non-Patent Document No. 1 discloses a multi-pulse type write pulse for a BD-RE as shown in FIG. 1.

In FIGS. 1(a) and 1(b), the intensity of the laser beam to radiate and the width and location of a pulse in the time axis direction are shown as exemplary parameters that determine the shape of a write pulse.

In performing a write operation with high density on a BD, the shorter the length of a mark, the more easily the shape of the mark will be affected by a subtle difference in the quantity of heat applied. That is why the parameters in the time axis direction, among other things, are defined to be changeable according to the mark length.

The parameters concerning the intensity of the laser beam to radiate shown in FIG. 1 include a write power Pw (101), an erase power Pe (102), a cooling power Pc (103) and a bottom power Pb (104).

It should be noted that the erase power Pe (102) represents a laser power that contributes to forming a space on a rewritable information recording medium such as a BD-RE. In a write-once information recording medium such as a BD-R on which information can be written only once in an unrecorded portion, that laser power is sometimes called a “space power Ps”.

The parameters concerning the time-axis direction shown in FIG. 1 include the top pulse width Ttop (105, 108, 112), the top pulse position dTtop (106, 109, 113), the last pulse width Tlp (110, 114), the cooling pulse end position dTe (107, 111, 115), each of which can have its value changed on a mark length basis, and a multi-pulse width Tmp (116) representing 4T or a even longer length (where T represents one channel clock period).

All of those parameters about write pulses are stored in advance in an information recording medium.

Even if those parameters about write pulses are stored on an information recording medium, some or all of the parameters representing a laser power, a pulse width and a pulse position may sometimes be stored by an information recording medium read/write device in a designated area on an information recording medium or in an internal memory of the read/write device.

### CITATION LIST

### Non-Patent Literature

Non-Patent Document No. 1: Illustrated Blu-ray Disc Reader, published by Ohmsha, Ltd.

### SUMMARY OF INVENTION

### Technical Problem

Recently, as the densities of information recording media have been increasing year by year, the shortest mark length of recorded marks has come closer and closer to the limit of resolution that depends on the detection system.

If the information recording medium is an optical disc medium, for example, the “resolution that depends on the detection system” refers to the optical resolution to be determined by the size of a light beam spot being formed by condensing a laser beam.

Since the shortest mark length is on the verge of reaching that limit of resolution, an increase in intersymbol interference and a decrease in SNR (signal to noise ratio) have become more and more significant these days.

Hereinafter, the storage density will be described with reference to FIGS. 2, 3, and 4.

FIG. 2(a) illustrates an example of a 25 GB BD, for which the laser beam 201 is supposed to have a wavelength of 405 nm and the objective lens 202 is supposed to have a numerical aperture (NA) of 0.85.

As in a DVD, data is also written on the track 200 of a BD as a series of marks 203, 204 that are produced as a result of a physical variation. The shortest one of this series of marks will be referred to herein as the “shortest mark”. In FIG. 2(a), the mark 204 is the shortest mark.

In a BD with a storage capacity of 25 GB, the shortest mark 204 has a physical length of 0.149 μm, which is approximately 1/2.7 of the shortest mark of a DVD. And even if the resolution of a laser beam is increased by changing the parameters of an optical system such as the wavelength (405 nm) and the NA (0.85), this value is still rather close to the limit of optical resolution, below which recorded marks are no longer sensible for the light beam.

FIG. 3 illustrates a state where a light beam spot has been formed on the series of recorded marks on the track. In a BD, the light beam spot 205 has a diameter of approximately 0.39 μm, which may vary with parameters of the optical system. If the storage linear density is increased without changing the structures of the optical system, then the recorded marks will shrink for the same spot size of the light beam spot 205 and the read resolution will decrease.

On the other hand, FIG. 2(b) illustrates an example of an optical disc with an even higher storage density than a 25 GB BD. But even for such a disc, the laser beam 201 is also supposed to have a wavelength of 405 nm and the objective lens 202 is also supposed to have a numerical aperture (NA) of 0.85. Among the series of marks 206, 207 of such a disc, the shortest mark 206 has a physical length of 0.1115 μm. Compared to FIG. 2(a), the spot size remains approximately 0.39 μm but both the recorded marks and the interval between the marks have shrunk. As a result, the read resolution will decrease.

The shorter a recorded mark, the smaller the amplitude of a read signal to be generated when the recorded mark is scanned with a light beam. And the amplitude goes zero when the mark length gets equal to the limit of optical resolution. The inverse number of one period of these recorded marks is called a “spatial frequency”. The transfer function of the spatial frequency is called an “optical transfer function (OTF)”. And a function representing the amplitude dependence of the OTF with respect to the spatial frequency is called a “modulation transfer function (MTF)”, which is represented by the following approximation function:

$$MTF = \frac{2}{π} \times ( a cos ( x ) - x \sqrt{1 - {x}^{2}} ) \qquad ( 1 )$$

if x=λ/(4×P×NA) (where P represents the length of a recorded mark, NA represents the numerical aperture of a lens, and λ represents the wavelength) is satisfied.

As the spatial frequency rises, the signal amplitude represented by MTF decreases almost linearly. And the readable limit frequency (when x=1) at which the amplitude of the signal goes zero is called an MTF cutoff. Then, P=λ/(4×NA) is satisfied. As for a BD, the wavelength λ=405 nm and NA=0.85, and therefore, P becomes approximately 119 nm.

FIG. 4 is a graph showing how the MTF of a BD with a storage capacity of 25 GB per storage plane changes with the shortest recorded mark length. The spatial frequency of the shortest mark on a BD is approximately 80% of, and is lower than, the MTF cutoff frequency. It can also be seen that even in a BD with a storage density of 25 GB, a read signal representing the shortest mark has amplitude that is as small as approximately 10% of the amplitude of a long mark. The storage capacity at which the spatial frequency of the shortest mark on a BD is very close to the OTF cutoff frequency (i.e., the storage capacity at which the read signal has almost no amplitude) corresponds to approximately 31.3 GB in a BD. When the frequency of the read signal representing the shortest mark comes close to, or exceeds, the MTF cutoff frequency, the limit of optical resolution may have been reached or already surpassed for the laser beam. As a result, it becomes very difficult to record a mark on an optical disc and to scan the mark thus recorded. FIG. 2 schematically illustrates a light beam and recorded marks when a series of marks are recorded on an optical disc using a light beam. Specifically, FIG. 2(a) illustrates a situation where the shortest recorded mark has a length of 149 nm. In that case, every mark is recorded so that its associated frequency does not exceed the MTF cutoff frequency. On the other hand, FIG. 2(b) illustrates a situation where the storage density of the optical disc has been further increased. In that case, some recorded marks have such a length that is associated with a frequency that exceeds the MTF cutoff frequency representing the limit of the optical resolution. As a result, marks that are even shorter than the limit of the optical resolution and marks that are equal to or longer than the limit of the optical resolution will both be recorded on the same optical disc. FIG. 5 shows a situation where the spatial frequency of the shortest mark (2T) is higher than the MTF cutoff frequency but where those of the other marks are lower than the MTF cutoff frequency. In that case, supposing the track pitch and the disc size are the same as those of a BD, the storage density will be approximately 33.3 GB. As the storage density continues to increase as described above, marks of a required length or less should be recorded on a disc in a size associated with a frequency that is even higher than the spatial frequency representing the limit of optical resolution. As a result, it becomes difficult to make a recorded mark with good stability by a conventional writing method. That is why there is a demand for a writing method for recording a mark with good stability even if the spatial frequency becomes equal to or higher than the MTF cutoff frequency.

To actually use such a high-density optical disc as an information recording medium without problems, not just the write operation needs to be done with stability in such a frequency range that exceeds the MTF cutoff frequency but also the optical disc should maintain good stability even under various other stresses. Examples of those stresses include a variation from one information recording medium to another, a variation within each single information storage plane thereof, a variation between write pulses in the time axis direction, varying focusing states of a laser beam, and varying tracking control states.

As an example, it will be described with reference to FIG. 6 how to record a mark with a length of 2T. In the example illustrated in FIG. 6, a 2T mark 602 is recorded with a 2T write pulse 601. For the purpose of comparison, a 3T mark 603, which is 1T longer than the 2T mark 602, is also shown in FIG. 6.

The 2T write pulse 601 is represented by the three laser beam radiation intensity levels defining the write power Pw (101), erase power Pe (102), and cooling power Pc (103), the period at the write power Pw (101) level identified by 2T-Ttop (105), and the end of the period at the cooling power Pc (103) level identified by 2T-dTe (107). Speaking more generally, in this description, “xT-Ttop” denotes Ttop of an xT mark and “xT-dTe” denotes dTe of the xT mark. The same notation will apply herein to dTtop, Tlp and other reference signs.

By applying the write power Pw (101) to an information recording medium, a quantity of heat that causes some change on a storage plane of the information recording medium is given to the recording medium. As for a write-once information recording medium, ordinarily some change is made and information gets written thereon just by giving a quantity of heat to it. As for a rewritable medium, on the other hand, a mark is usually recorded thereon by cooling the medium rapidly with the cooling power.

However, to increase the storage density of an optical disc and to record a mark, of which the size is associated with a spatial frequency that exceeds the limit of the optical resolution of a light beam, the width of the write pulse 601 needs to be decreased so that the recorded mark will have a narrower width. Nevertheless, if the pulse width were decreased to less than a certain level, then the quantity of heat applied to the recording medium would be too little to record a mark as intended. On top of that, if one mark is recorded with a resolution that exceeds that of the spatial frequency of the light beam, the optical interference between that mark and the next mark will increase too much to form such small recorded marks with good stability by a conventional writing method.

That is to say, the conventional method described above is designed on the supposition that the length of a mark to record is still longer than the limit of the optical resolution of a laser beam, and never anticipates a situation where a mark that is even shorter than the limit of the optical resolution of the laser beam should be recorded. That is why to record such a mark that is even shorter than the limit of the optical resolution as intended, it is not a good idea to use the conventional method, considering the difficulty, but a different method should be used instead.

It is therefore an object of the present invention to provide a method and device for writing, which can be used effectively to write such a mark that is even shorter than the limit of the optical resolution with good stability on an information recording medium with an increased density and also provide an information recording medium on which a condition for performing such a write operation is stored.

### Solution to Problem

A writing method according to the present invention is a method for writing a data sequence as a combination of marks and spaces on an information recording medium by condensing a laser beam through a lens. The writing method is characterized in that a cooling pulse for recording a mark that is even shorter than the limit of optical resolution of the laser beam and another cooling pulse for recording a mark that is still longer than the limit of the optical resolution of the laser beam are applied under mutually different conditions.

In one preferred embodiment, if a mark length is P, the wavelength of the laser beam is λ and the numerical aperture of the lens is NA, the mark that is shorter than the limit of the optical resolution of the laser beam satisfies P≦λ/4NA, while the mark that is still longer than the limit of the optical resolution of the laser beam satisfies P>λ/4NA.

In this particular preferred embodiment, the width of the cooling pulse for recording the mark that satisfies Pc λ/4NA is set to be equal to zero, and the width of the cooling pulse for recording the mark that satisfies P>λ/4NA is set to be not equal to zero.

In another preferred embodiment, when the mark that satisfies P≦λ/4NA is recorded, the width of the cooling pulse is always set to be equal to zero, irrespective of the lengths of the two spaces that respectively precede and follow the mark. On the other hand, when the mark that satisfies P>λ/4NA is recorded, the width of the cooling pulse is set to be not equal to zero according to the length of at least one of the two spaces that respectively precede and follow the mark.

A writing device according to the present invention is an device for writing a data sequence as a combination of marks and spaces on an information recording medium. The device includes an optical head section including a lens that condenses a laser beam and a control section for controlling the pulse shape of a write signal. The device is characterized in that the control section makes a condition for applying a cooling pulse to record a mark that is even shorter than the limit of optical resolution of the laser beam different from a condition for applying another cooling pulse to record a mark that is still longer than the limit of the optical resolution of the laser beam.

In one preferred embodiment, if a mark length is P, the wavelength of the laser beam is λ and the numerical aperture of the lens is NA, the mark that is shorter than the limit of the optical resolution of the laser beam satisfies P≦λ/4NA, and the mark that is still longer than the limit of the optical resolution of the laser beam satisfies P>λ/4NA.

In this particular preferred embodiment, the control section sets the width of the cooling pulse for recording the mark that satisfies P≦λ/4NA to be equal to zero, and also sets the width of the cooling pulse for recording the mark that satisfies P>λ/4NA to be not equal to zero.

In another preferred embodiment, when the mark that satisfies P≦λ/4NA is recorded, the control section always sets the width of the cooling pulse to be equal to zero, irrespective of the lengths of the two spaces that respectively precede and follow the mark. On the other hand, when the mark that satisfies P>λ/4NA is recorded, the control section sets the width of the cooling pulse to be not equal to zero according to the length of at least one of the two spaces that respectively precede and follow the mark.

On an information recording medium according to the present invention, a data sequence is written as a combination of marks and spaces by being irradiated with a laser beam that has been condensed through a lens. The recording medium is characterized by having a disc information area on which stored is a writing condition that is defined so that a cooling pulse for recording a mark that is even shorter than the limit of optical resolution of the laser beam and another cooling pulse for recording a mark that is still longer than the limit of the optical resolution of the laser beam are applied under mutually different conditions.

### Advantageous Effects of Invention

According to the present invention, a cooling pulse for recording a mark that is even shorter than the limit of optical resolution of the laser beam and another cooling pulse for recording a mark that is still longer than the limit of the optical resolution of the laser beam are applied under mutually different conditions. That is why even such a mark that is shorter than the limit of optical resolution of the laser beam can also be recorded with good stability. As a result, an information recording medium with very high storage density, and a method and device for writing information such an information recording medium are realized. Also, by storing such a writing condition on an information recording medium in advance, the information recording medium will have such a high degree of compatibility that a read/write operation can be done on it with good stability, no matter what device is loaded with that recording medium.

In addition, in one preferred embodiment of the present invention, when a mark that is even shorter than the limit of the optical resolution of the laser beam (i.e., the mark that satisfies P≦λ/4NA) is recorded, the width of the cooling pulse is always set to be equal to zero, irrespective of the lengths of the two spaces that respectively precede and follow the mark. On the other hand, when a mark that is still longer than the limit of the optical resolution of the laser beam (i.e., the mark that satisfies P>λ/4NA) is recorded, the width of the cooling pulse is set to be not equal to zero according to the length of at least one of the two spaces that respectively precede and follow the mark. As a result, a write operation can be carried out with good stability without being thermally interfered with by the preceding or following space.

### BRIEF DESCRIPTION OF DRAWINGS

FIGS. 1(a) and 1(b) show examples of write pulse parameters and write pulse shapes.

FIG. 2(a) illustrates an example of a 25 GB BD, and FIG. 2(b) illustrates an example of an optical disc with an even higher storage density than a 25 GB BD.

FIG. 3 is a schematic representation illustrating how a series of marks on a track is irradiated with a light beam.

FIG. 4 is a graph showing how the OTF of a BD with a storage capacity of 25 GB changes with the shortest recording mark length.

FIG. 5 is a graph showing how the signal amplitude changes with the spatial frequency in a situation where the spatial frequency of the shortest mark (2T) is higher than the OTF cutoff frequency and where the 2T read signal has zero amplitude.

FIG. 6 illustrates how to record a 2T mark with a 2T write pulse.

FIG. 7 illustrates an optical disc drive according to the first preferred embodiment of the present invention.

FIG. 8A illustrates an example of an N/2 type write strategy including 2T, 3T and 8T write pulses.

FIG. 8B illustrates an example of an N/2 type write strategy including 4T and 5T write pulses.

FIG. 8C illustrates an example of an N/2 type write strategy including 6T and 7T write pulses.

FIG. 9A shows examples of pulse width and pulse position parameters for write pulses according to the N/2 type write strategy of the first preferred embodiment of the present invention.

FIG. 9B is a table that summarizes the conditions satisfied by 2T write pulse parameters according to the first preferred embodiment of the present invention.

FIG. 10 illustrates an example of an N/2 write strategy according to the first preferred embodiment of the present invention.

FIG. 11 illustrates an example of an N−1 write strategy.

FIG. 12 shows examples of pulse width and pulse position parameters for write pulses according to the N−1 type write strategy.

FIG. 13 illustrates an example of a castle type write strategy.

FIG. 14 shows examples of pulse width and pulse position parameters for write pulses according to the castle type write strategy.

FIG. 15 is a table that summarizes the conditions satisfied by 2T write pulse parameters for the N−1 type write strategy according to the second preferred embodiment of the present invention.

FIG. 16 illustrates an example of an N−1 type write strategy according to a second preferred embodiment of the present invention.

FIG. 17 illustrates an example of an N/2 type write strategy according to a third preferred embodiment of the present invention.

FIG. 18 illustrates an information recording medium according to a preferred embodiment of the present invention.

FIG. 19 illustrates an information recording medium according to a preferred embodiment of the present invention.

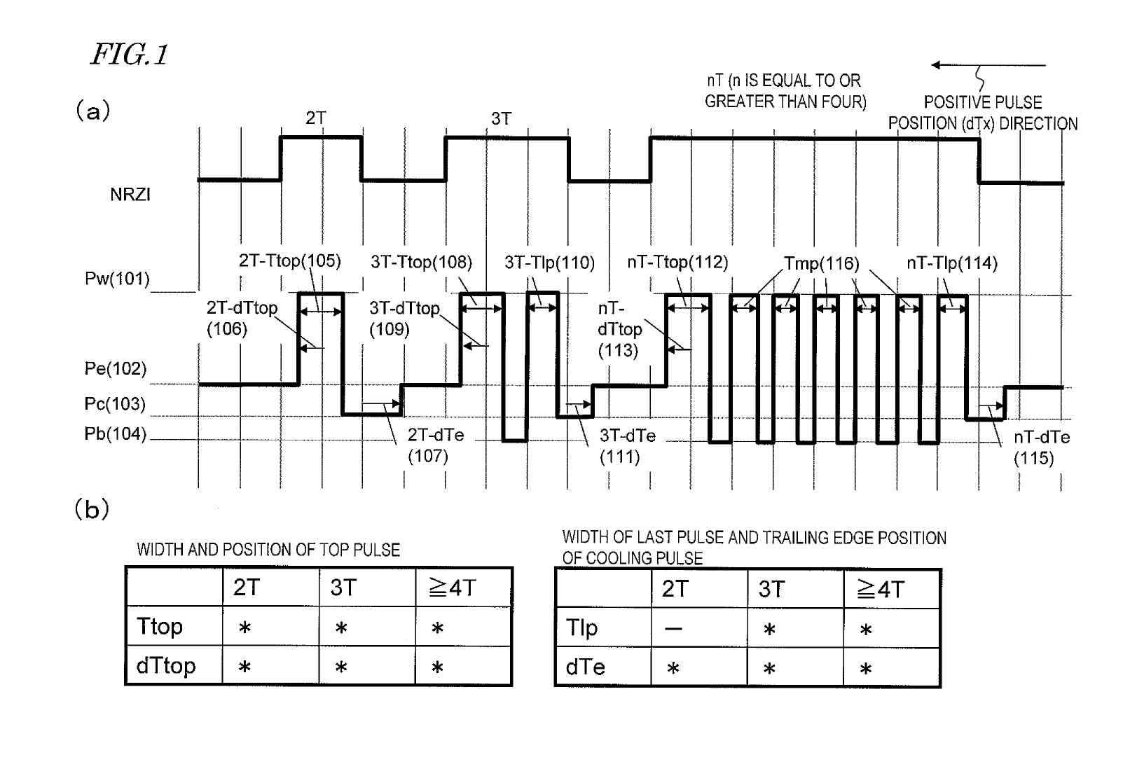

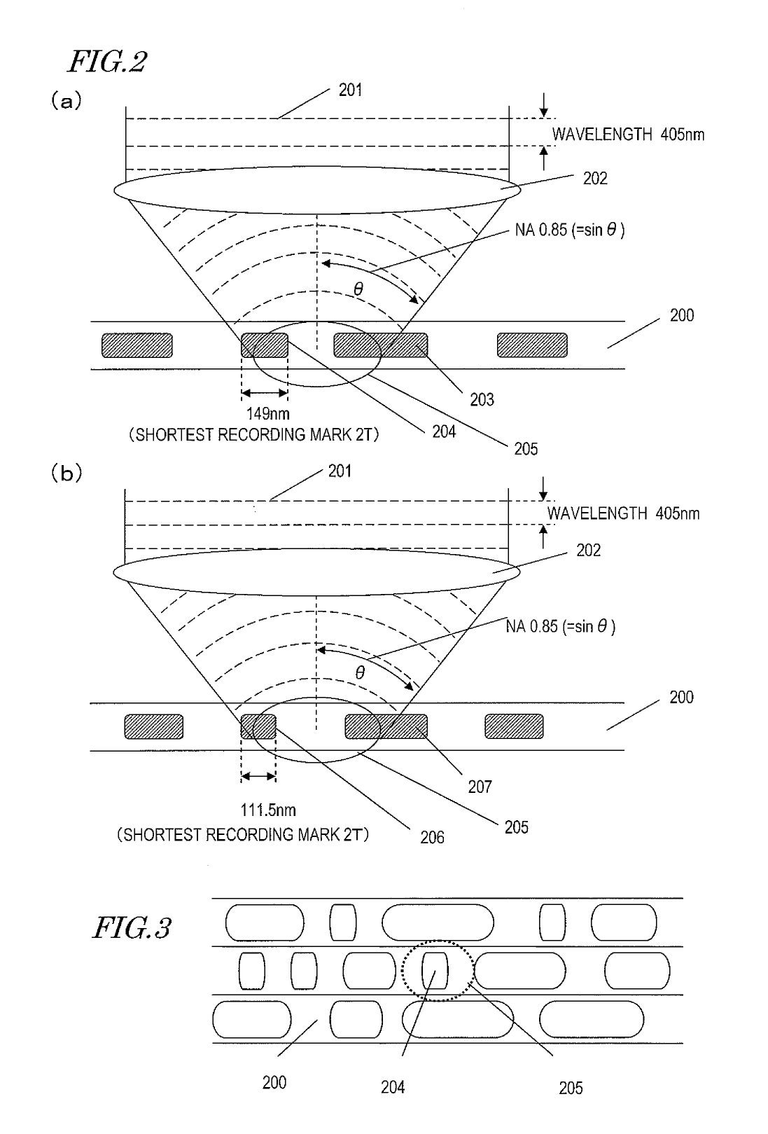

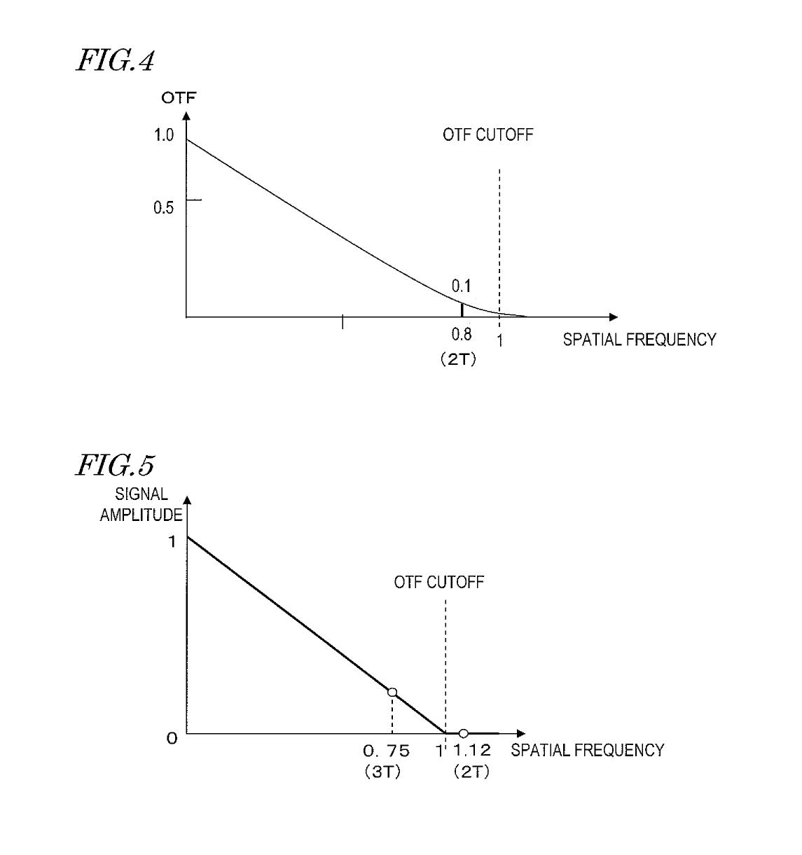

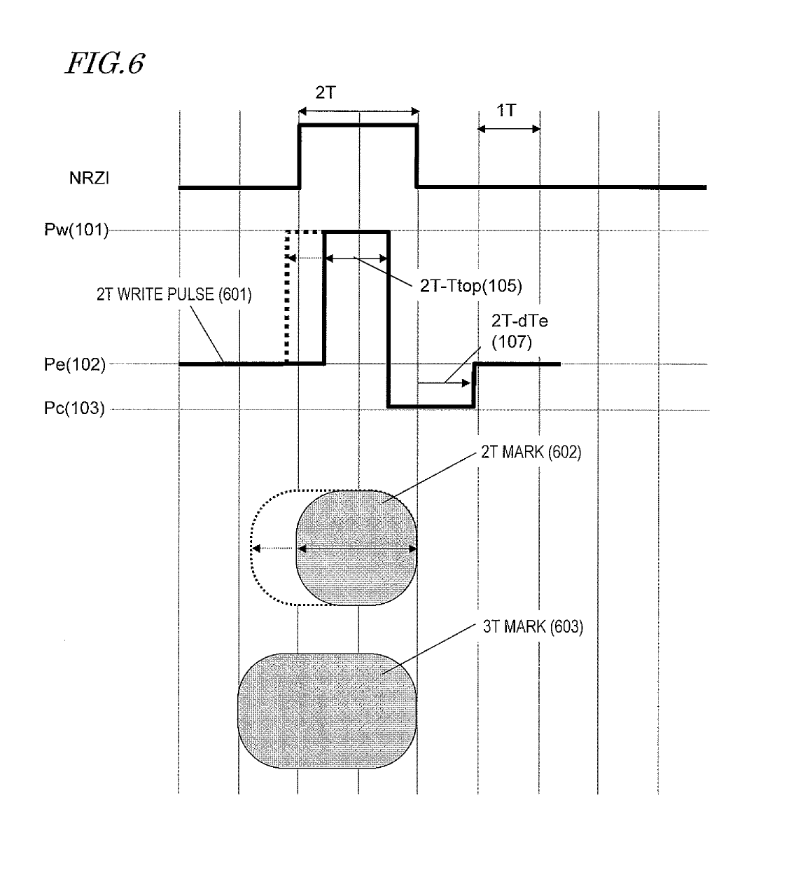

### DESCRIPTION OF EMBODIMENTS

Hereinafter, preferred embodiments of the present invention will be described with reference to the accompanying drawings. In the following description, any pair of components shown in multiple drawings and having substantially the same function will be identified by the same reference numeral. And once such a component has been described, the description of its counterpart will be omitted herein to avoid redundancies.

### Embodiment 1

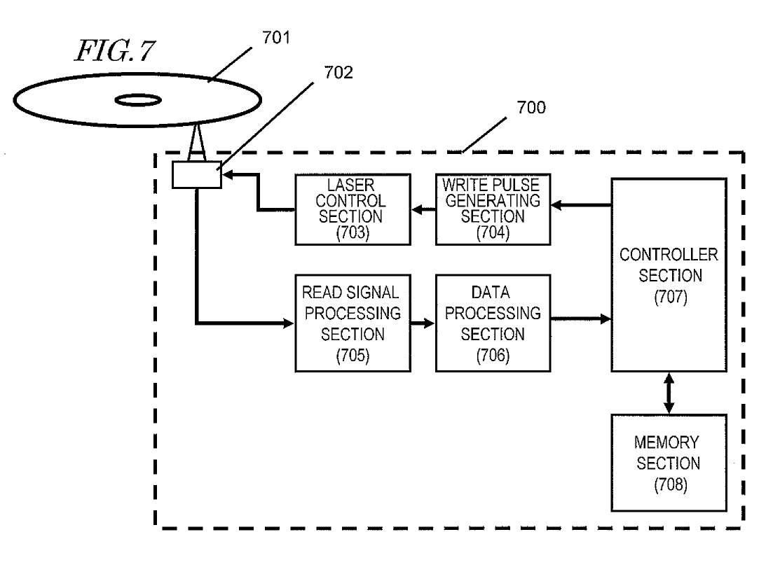

First of all, it Will be Described What Optical disc drive is used to write information on an information recording medium according to a first preferred embodiment of the present invention. FIG. 7 illustrates an optical disc drive 700 according to the first preferred embodiment of the present invention. The optical disc drive 700 is an example of a writing device for writing information on an information recording medium 701 loaded. The optical disc drive 700 may also read information from the information recording medium 701. The information recording medium 701 is a rewritable recording medium and is supposed to be a phase-change type rewritable optical disc in this preferred embodiment. The optical disc drive 700 includes an optical head section 702, a laser control section 703, a write pulse generating section 704, a read signal processing section 705, a data processing section 706, a controller section 707, and a memory section 708.

First of all, it will be described how this optical disc drive 700 performs a read operation. The optical head section 702 converges a laser beam, which has been transmitted through an objective lens, onto a target recording layer of the information recording medium 701 and receives the light reflected from it, thereby generating an analog read signal representing the information stored on the information recording medium 701. The analog read signal retrieved from the information recording medium 701 is subjected to signal processing by the read signal processing section 705, which then passes a digital signal generated to the data processing section 706. In response, the data processing section 706 generates read data based on the digital signal received and then provides that data for the controller section 707.

Next, it will be described how this optical disc drive 700 performs a write operation. First, the controller section 707 supplies write data and write pulse parameters to the write pulse generating section 704. Those write pulse parameters are stored on the information recording medium 701. The write pulse generating section 704 generates a write signal based on the write data received and write pulse parameters (i.e., adjusts the pulse shape of the write signal) and then provides that write signal for the laser control section 703. On receiving the write signal generated, the laser control section 703 controls the emission pattern of a laser beam from a laser diode built in the optical head section 702 in accordance with the write signal, thereby recording marks on the information recording medium 701. The laser beam is condensed onto the information recording medium 701 by the lens of the optical head section 702, thereby writing a data sequence as a combination of marks and spaces on the information recording medium 701.

In this preferred embodiment, the laser beam has a wavelength of 405 nm, the lens has a numerical aperture of 0.85, the 1-7 coding system is used as write modulation code, and the track pitch is 320 nm. If information is written on a disc with the 1-7 modulation code, the shortest recorded mark will have a length of 2T, where T represents the length of one channel clock period. Also, a mark size associated with the MTF cutoff frequency to be determined by NA and A is calculated to be 119 nm by P=λ/(4×NA). Since the shortest mark size 2T=111.6 nm in this preferred embodiment, the 2T mark is shorter than P but 3T or longer marks are longer than P. If the 2T mark size is 111.5 nm, a disc of the same size as a 12 cm BD can have a storage capacity (or density) of approximately 33.4 GB per recording layer because the track pitch is 320 nm. This storage density of 33.4 GB is about 1.3 times as high as 25 GB that is the storage density of a BD. Hereinafter, a writing method that achieves such high density will be described in detail.

To achieve such high storage density as that of this preferred embodiment, marks need to be recorded at higher frequencies than the MTF cutoff frequency representing the limit of the optical resolution. In this preferred embodiment, 3T through 9T marks are recorded by the 1-7 modulation at frequencies that are equal to or lower than the MTF cutoff frequency, but 2T marks are recorded at frequencies that are higher than the MTF cutoff frequency. According to this preferred embodiment, 2T marks can also be recorded at such high frequencies that exceed the limit of optical resolution by setting a different cooling pulse condition on 2T marks from the ones on the other recorded marks.

Specifically, when a mark that is even shorter than the limit of the optical resolution of a light beam (i.e., a mark that satisfies P≦λ/4NA) is recorded, the width of the cooling pulse is always set to be equal to zero, irrespective of the lengths of the two spaces that respectively precede and follow the mark. On the other hand, when a mark that is still longer than the limit of the optical resolution (i.e., a mark that satisfies P>λ/4NA) is recorded, the width of the cooling pulse is set to be not equal to zero according to the length of at least one of the two spaces that respectively precede and follow the mark. Hereinafter, a specific example of such a write pulse generating method will be described.

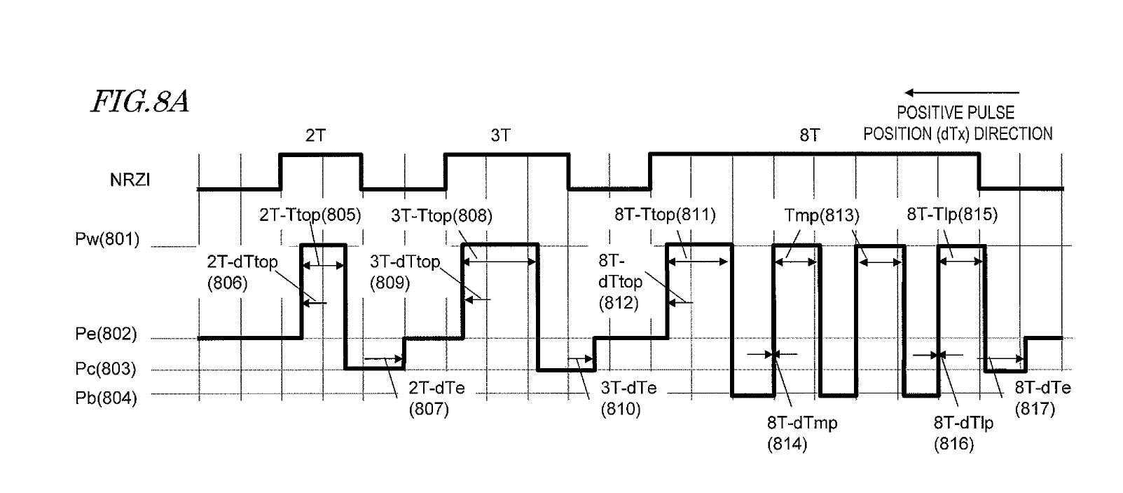

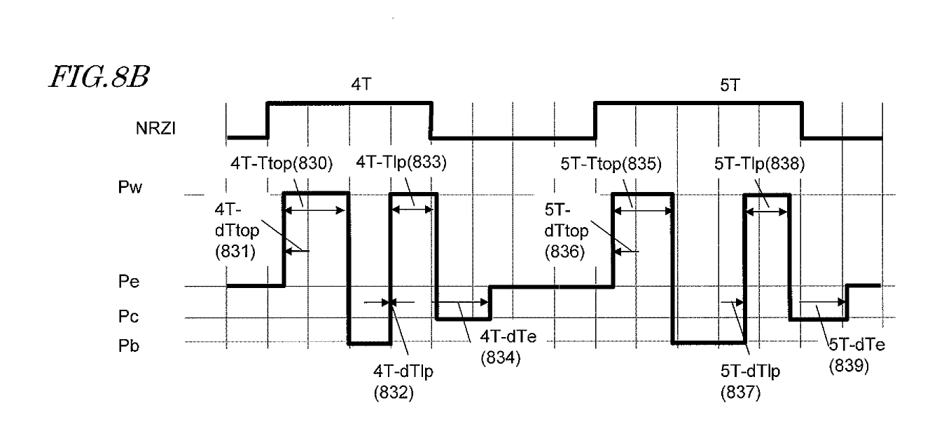

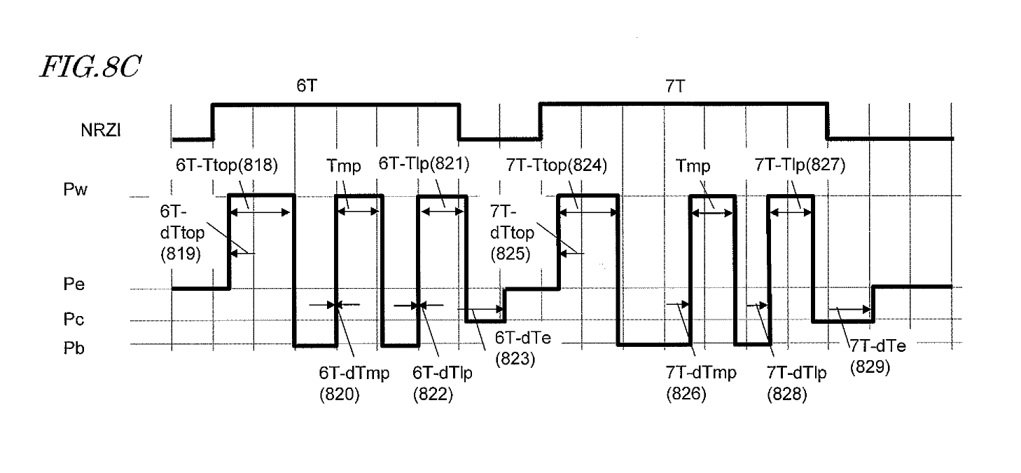

FIGS. 8A to 8C illustrate a so-called “N/2 type” write strategy. As an example, a RLL (1, 7) recording code is used to form recorded marks including 2T (that is the shortest one and where T is a channel clock pulse width) through 8T marks and 9T marks for use as a sync pattern to detect a particular timing such as a data starting point. FIGS. 8A to 8C illustrate the write pulse waveforms of those 2T through 8T marks.

The 2T mark of the N/2 type write strategy shown in FIG. 8A includes a top pulse, which starts at a point in time defined by 2T-dTtop 806 and which contributes to emitting a laser beam at a write power Pw (801) for a period of time defined by 2T-Top 805, and a cooling pulse, which contributes to emitting a laser beam at a cooling power Pc (803) from a point in time when the top pulse falls through a point in time when the power rises from the cooling power Pc (803) to the erase power Pe (802) as defined by 2T-dTe 807.

The 3T mark of the N/2 type write strategy shown in FIG. 8A includes a top pulse, which starts at a point in time defined by 3T-dTtop 809 and which contributes to emitting a laser beam at a write power Pw (801) for a period of time defined by 3T-Top 808, and a cooling pulse, which contributes to emitting a laser beam at a cooling power Pc (803) from a point in time when the top pulse falls through a point in time when the power rises from the cooling power Pc (803) to the erase power Pe (802) as defined by 3T-dTe 810.

The 4T mark of the N/2 type write strategy shown in FIG. 8B includes: a top pulse, which starts at a point in time defined by 4T-dTtop 831 and which contributes to emitting a laser beam at the write power Pw (801) for a period of time defined by 4T-Top 830; a last pulse, which starts at a point in time defined by 4T-dTlp 832 as a reference time that is 1T before NRZI falls and which contributes to emitting a laser beam at the write power Pw (801) for a period of time defined by 4T-Tlp 833; a bottom pulse, which contributes to emitting a laser beam at a bottom power Pb (804) from a point in time when the top pulse falls through a point in time when the last pulse rises; and a cooling pulse, which contributes to emitting a laser beam at a cooling power Pc (803) from a point in time when the last pulse falls through a point in time when the power rises from the cooling power Pc (803) to the erase power Pe (802) as defined by 4T-dTe 834.

The 5T mark of the N/2 type write strategy shown in FIG. 8B includes: a top pulse, which starts at a point in time defined by 5T-dTtop 836 and which contributes to emitting a laser beam at the write power Pw (801) for a period of time defined by 5T-Top 835; a last pulse, which starts at a point in time defined by 5T-dTlp 837 as a reference time that is 2T before NRZI falls and which contributes to emitting a laser beam at the write power Pw (801) for a period of time defined by 5T-Tlp 838; a bottom pulse, which contributes to emitting a laser beam at a bottom power Pb (804) from a point in time when the top pulse falls through a point in time when the last pulse rises; and a cooling pulse, which contributes to emitting a laser beam at a cooling power Pc (803) from a point in time when the last pulse falls through a point in time when the power rises from the cooling power Pc (803) to the erase power Pe (802) as defined by 5T-dTe 839.

The 6T mark of the N/2 type write strategy shown in FIG. 8C includes: a top pulse, which starts at a point in time defined by 6T-dTtop 819 and which contributes to emitting a laser beam at the write power Pw (801) for a period of time defined by 6T-Top 818; a last pulse, which starts at a point in time defined by 6T-dTlp 822 as a reference time that is 1T before NRZI falls and which contributes to emitting a laser beam at the write power Pw (801) for a period of time defined by 6T-Tlp 821; multiple pulses, which start 3T after NRZI has risen and which contribute to emitting a laser beam at the write power Pw (801) for a period of time defined by Tmp 813; a bottom pulse, which contributes to emitting a laser beam at a bottom power Pb (804) from a point in time when the top pulse falls through a point in time when the multiple pulses rise and from a point in time when the multiple pulses fall through a point in time when the last pulse rises; and a cooling pulse, which contributes to emitting a laser beam at a cooling power Pc (803) from a point in time when the last pulse falls through a point in time when the power rises from the cooling power Pc (803) to the erase power Pe (802) as defined by 6T-dTe 823.

The 7T mark of the N/2 type write strategy shown in FIG. 8C includes: a top pulse, which starts at a point in time defined by 7T-dTtop 825 and which contributes to emitting a laser beam at the write power Pw (801) for a period of time defined by 7T-Top 824; a last pulse, which starts at a point in time defined by 7T-dTlp 828 as a reference time that is 2T before NRZI falls and which contributes to emitting a laser beam at the write power Pw (801) for a period of time defined by 7T-Tlp 827; multiple pulses, which start 3T after NRZI has risen as defined by 7T-dTmp 826 and which contribute to emitting a laser beam at the write power Pw (801) for a period of time defined by Tmp 813; a bottom pulse, which contributes to emitting a laser beam at a bottom power Pb (804) from a point in time when the top pulse falls through a point in time when the multiple pulses rise and from a point in time when the multiple pulses fall through a point in time when the last pulse rises; and a cooling pulse, which contributes to emitting a laser beam at a cooling power Pc (803) from a point in time when the last pulse falls through a point in time when the power rises from the cooling power Pc (803) to the erase power Pe (802) as defined by 7T-dTe 829.

The 8T mark of the N/2 type write strategy shown in FIG. 8A includes: a top pulse, which starts at a point in time defined by 8T-dTtop 812 and which contributes to emitting a laser beam at the write power Pw (801) for a period of time defined by 8T-Top 811; a last pulse, which starts at a point in time defined by 8T-dTlp 816 as a reference time that is 1T before NRZI falls and which contributes to emitting a laser beam at the write power Pw (801) for a period of time defined by 8T-Tlp 815; multiple pulses, which start 3T and 5T after NRZI has risen and which contribute to emitting a laser beam at the write power Pw (801) for a period of time defined by Tmp 813; a bottom pulse, which contributes to emitting a laser beam at a bottom power Pb (804) from a point in time when the top pulse falls through a point in time when the former multiple pulses rise, from a point in time when the former multiple pulses fall through a point in time when the latter multiple pulses rise and from a point in time when the latter multiple pulses fall through a point in time when the last pulse rises; and a cooling pulse, which contributes to emitting a laser beam at a cooling power Pc (803) from a point in time when the last pulse falls through a point in time when the power rises from the cooling power Pc (803) to the erase power Pe (802) as defined by 8T-dTe 817.

In FIGS. 8A, 8B and 8C, the bottom power Pb (804) is supposed to be lower than the cooling power Pc (803). However, this is just an example of the present invention. Alternatively, Pb=Pc or Pb>Pc may also be satisfied.

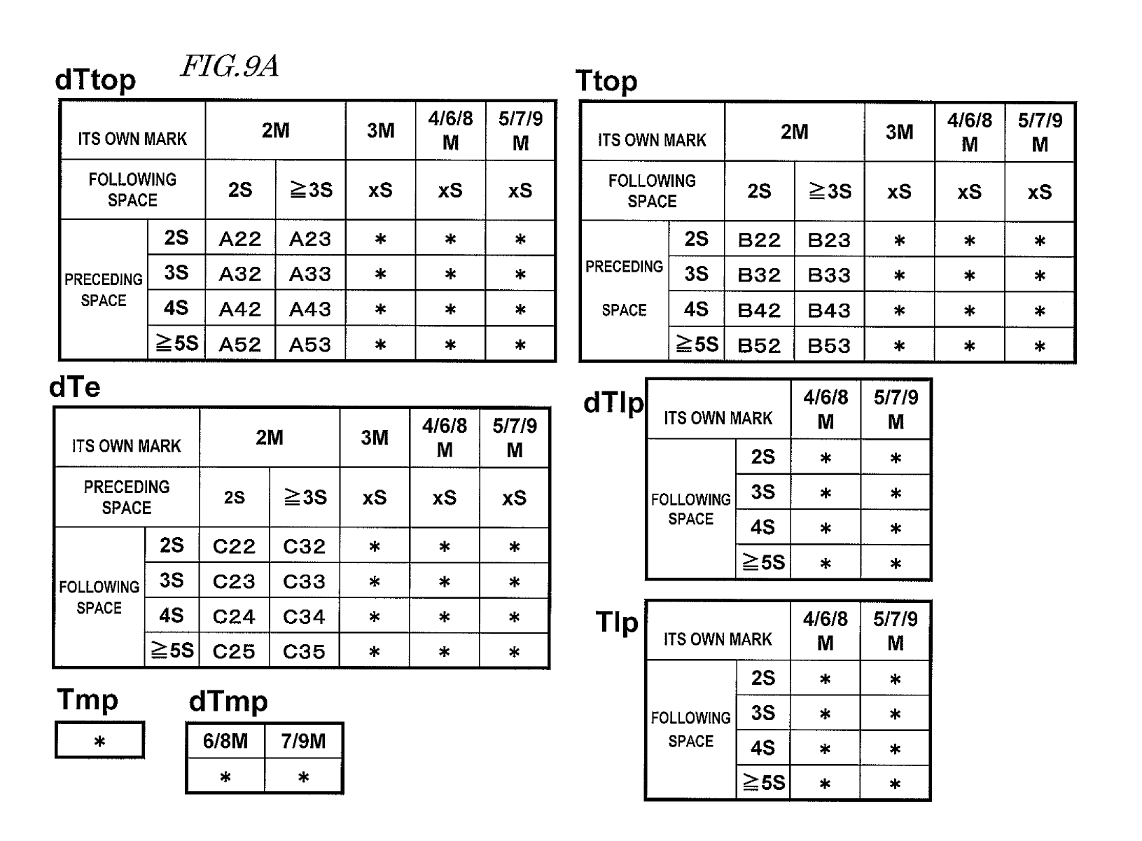

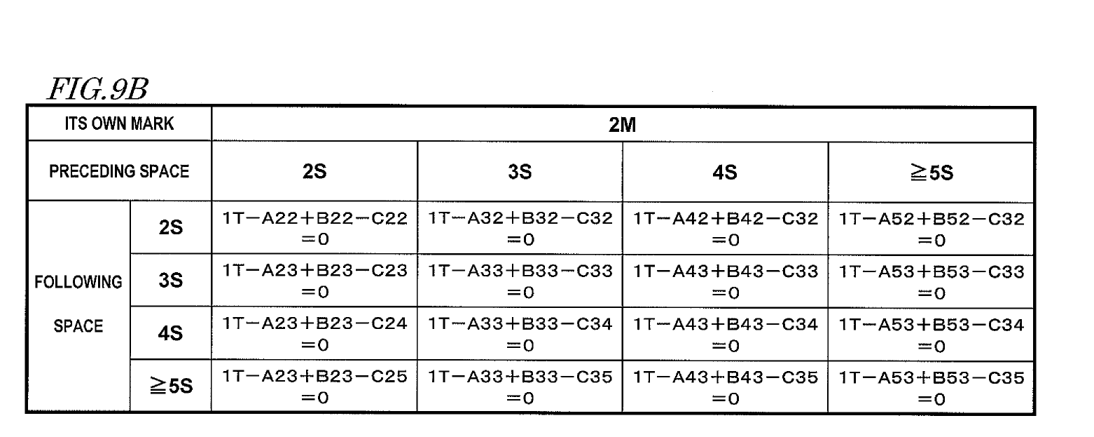

FIG. 9A shows examples of pulse width and pulse position parameters for write pulses according to the N/2 type write strategy.

Every parameter representing a pulse width is supposed to have a value that is equal to or greater than zero. On the other hand, each parameter representing a pulse position is supposed to have a positive value in the temporally retrograde direction (i.e., in the direction pointing toward the front edge) as shown in FIGS. 8A through 8C.

The respective top pulse start positions dTtop and respective top pulse widths Ttop of marks with xT lengths are supposed to be classified herein into the parameters of a 2T mark, those of a 3T mark, those of 4T or longer even-numbered T marks, and those of 5T or longer odd-numbered T marks.

Also, the dTtop and Ttop parameters are further classified into the four categories according to the length of the space that precedes each mark and that may be 2T, 3T, 4T or 5T or more. As for a 2T mark, the dTtop and Ttop parameters are further classified into the two categories according to the length of the space that follows the 2T mark and that may be 2T or 3T or more.

The respective cooling pulse end positions dTe of marks with xT lengths are supposed to be classified herein into the parameters of a 2T mark, those of a 3T mark, those of 4T or longer even-numbered T marks, and those of 5T or longer odd-numbered T marks.

The dTe parameters are further classified into the four categories according to the length of the space that follows each mark and that may be 2T, 3T, 4T or 5T or more. As for a 2T mark, the dTe parameters are further classified into the two categories according to the length of the space that precedes the 2T mark and that may be 2T or 3T or more.

The respective last pulse start positions dTlp and respective last pulse widths Tlp of 4T or longer marks with a last pulse are supposed to be classified herein into the parameters of 4T or longer even-numbered T marks and those of 5T or longer odd-numbered T marks.

Also, the dTlp and Tlp parameters are further classified into the four categories according to the length of the space that follows each mark and that may be 2T, 3T, 4T or 5T or more.

The respective multi-pulse start positions dTmp of 6T or longer marks with multiple pulses are supposed to be classified herein into the parameters of 6T or longer even-numbered T marks and those of 7T or longer odd-numbered T marks. On the other hand, the multi-pulse width Tmp is a parameter shared in common by every 6T or longer mark.

In this case, the dTtop, Ttop and dTe parameters of the 2T mark are set so as to satisfy the following Equation (2) with respect to every space that precedes or follows the 2T mark:

1T[ns]−Ttop[ns]+dTtop[ns]−dTe[ns]=0[ns] (2)

It should be noted that the calculation by this Equation (2) does not always have to be performed on an ns basis. Alternatively, if one step is an amount of time obtained by evenly dividing one T by k (where k is an integer) and if the pulse width, pulse position or every other parameter is represented by the number of steps, then Equation (2) may be modified into the following Equation (3):

K[step]−Ttop[step]+dTtop[step]−dTe[step]=0[step] (3)

It will be described what the signs shown in FIG. 9A stand for.

First of all, the dTtop table includes signs represented by “AXY”, of which “A” indicates dTtop and “XY” indicates the lengths of the spaces that respectively precede and follow the 2T mark. That is to say, “XY” refer to the lengths of an XT space and a YT space that respectively precede and follow the 2T mark.

For example, “A43” refers to dTtop of a 2T mark that is preceded by a 4T space and followed by a 3T or longer space.

FIG. 9B represents, as an equation using the signs shown in FIG. 9A, every possible combination of spaces that respectively precede and follow a 2T mark and that satisfy Equation (2) on a pattern-by-pattern basis.

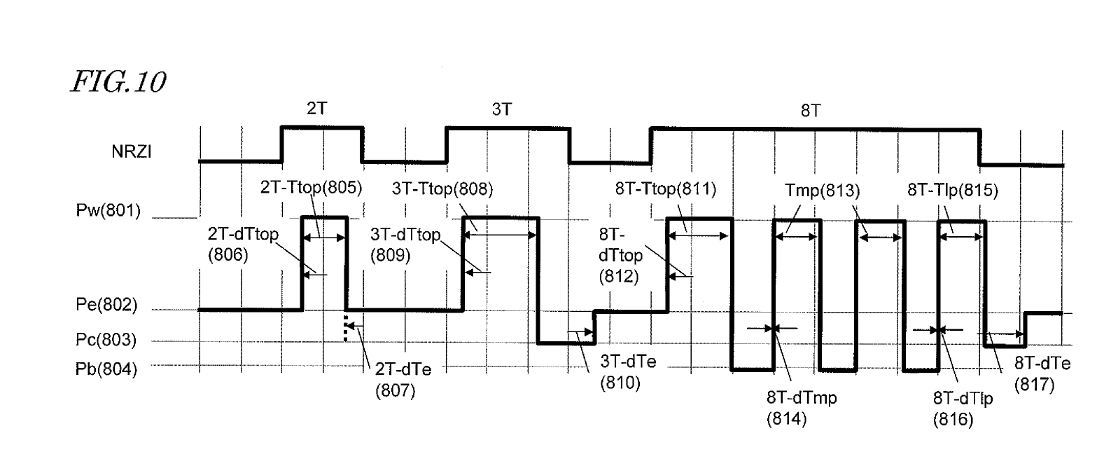

As a result, a 2T write pulse that forms a 2T mark becomes as shown in FIG. 10.

In FIG. 10, the point in time when the top pulse falls as defined by 2T-dTtop 806 and 2T-Top 805 agrees with the point in time when the power rises from the cooling power Pc (803) to the erase power Pe (802) as defined by 2T-dTe 807. Consequently, only the 2T write pulse has no cooling pulse that contributes to emitting a laser beam at the cooling power Pc (803), and a write operation is performed using only the top pulse.

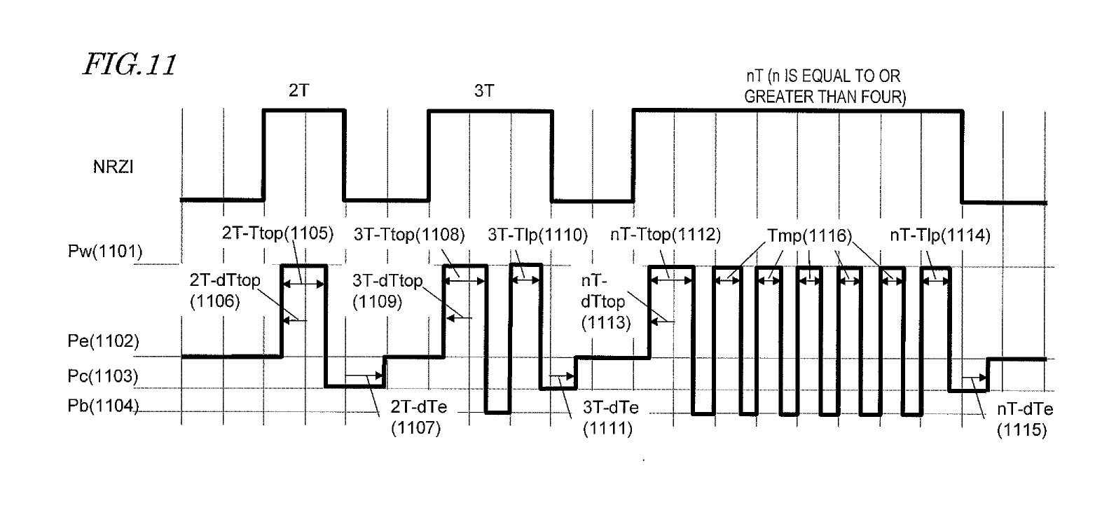

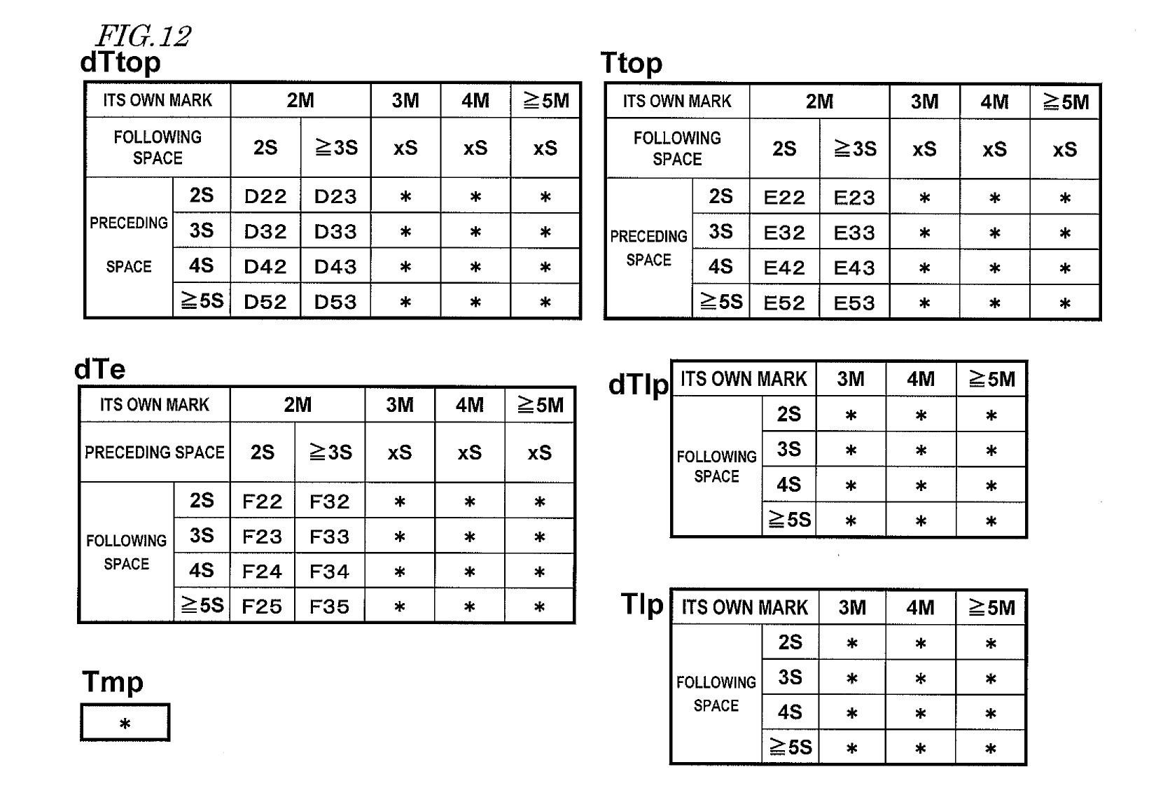

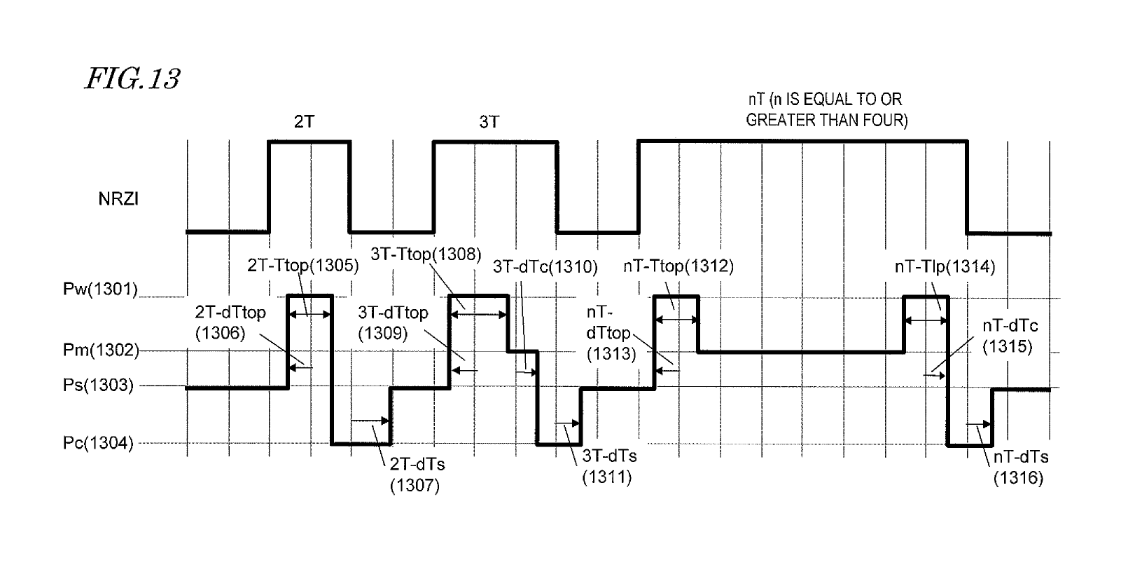

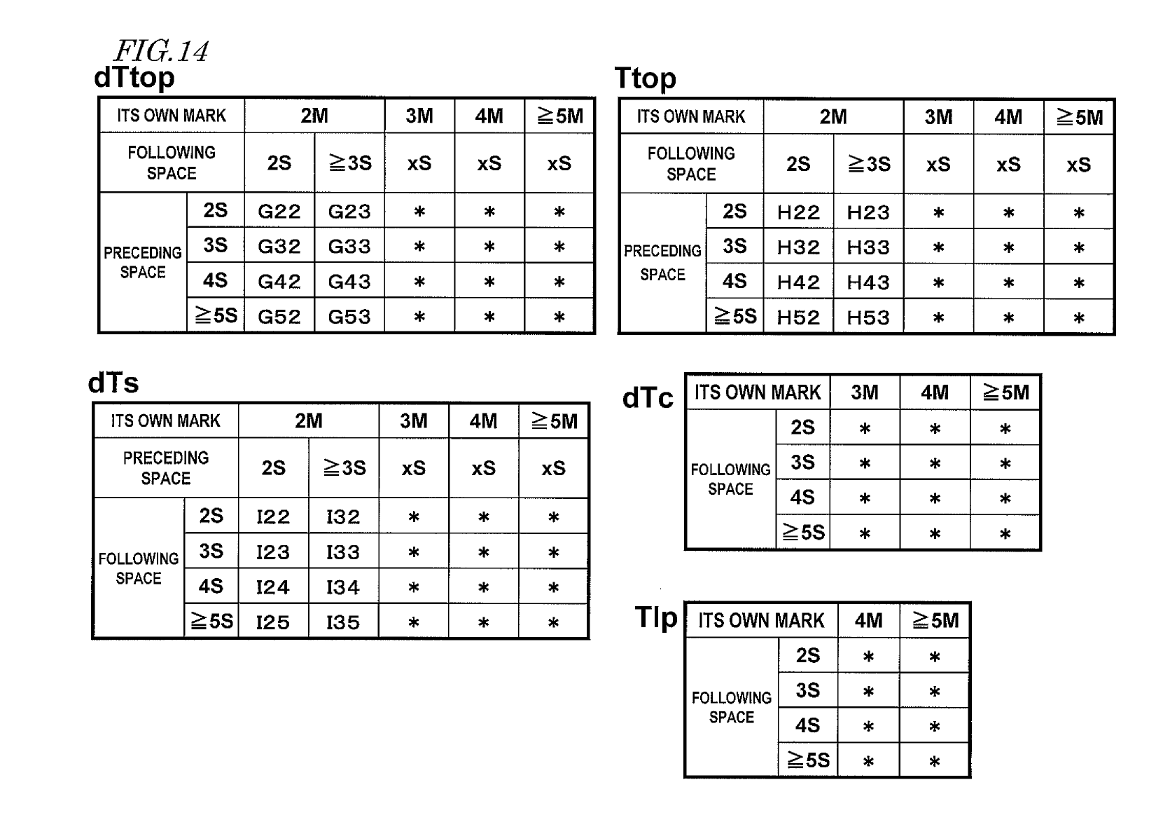

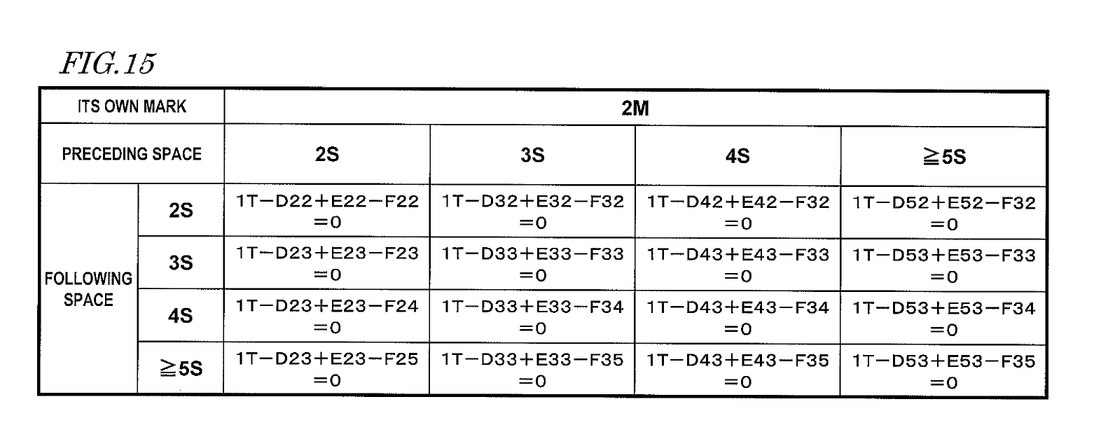

As described above, by making a cooling pulse condition for a 2T mark, which is even shorter than the limit of optical resolution, different from a one for 3T or longer marks, which are still longer than the limit of the optical resolution, a write operation can get done with very good stability. Hereinafter, the principle of such stabilized writing will be described. As described above, when a short mark is going to be recorded, the width of the write pulse may be narrowed. In that case, the quantity of heat applied can be decreased, and therefore, the size of the resultant recorded mark can be reduced to a certain degree. However, if the pulse width is decreased, then the quantity of heat applied to the recording medium decreases so much that the temperature will rise too little to get writing done easily. Particularly when a mark that is even shorter than the limit of optical resolution is going to be recorded, this problem becomes very serious. Thus, to overcome such a problem, according to this preferred embodiment, Ttop, which is the width of a write pulse, is broadened and no cooling pulse is applied to record the shortest 2T mark. In this manner, after a mark has been recorded once with good stability with the temperature of the recording medium raised by applying a pulse with a broad width, the power is decreased all the way down to the erase power at once without going through a cooling period using a cooling pulse. As a result, the recorded mark can be partially erased. Consequently, even a short mark can be recorded with the temperature raised with good stability. Nevertheless, if such a write mode that uses no cooling pulse power were applied to marks longer than 2T, which are still longer than the limit of optical resolution, the mark would be partially erased by the erase power, a recorded mark with a predetermined length could not be formed, and the storage density could not be increased. According to this preferred embodiment, by setting mutually different cooling pulse conditions for a 2T mark and non-2T marks as described above, this problem can be overcome. In the prior art, if the storage density is increased, marks cannot be recorded with stability and the jitter increases instead. On the other hand, according to this preferred embodiment, not only can the jitter be reduced by approximately 30% but also can the power margin be increased significantly as well. This is because by setting mutually different cooling pulse writing conditions for a 2T mark that is shorter than the limit of optical resolution and for other non-2T marks, the length of a recorded mark changes uniformly with a variation in power. The present invention is applicable to the N−1 type write strategy shown in FIGS. 11 and 12 and to the so-called “castle type” write strategy shown in FIGS. 13 and 14. The effect of this preferred embodiment can be achieved most significantly when a write operation is performed on a recorded mark that is even shorter than the limit of optical resolution under a writing condition that no cooling pulse should be used. This conclusion can also be derived from the principle of recording the shortest mark as described above.

In the preferred embodiment described above, the write pulse parameters are supposed to be classified into the four categories according to the length of a space that precedes or follows a recorded mark and that may be 2T, 3T, 4T or 5T or more. However, the present invention is in no way limited to that specific preferred embodiment. Alternatively, the parameters may be classified more finely into the five categories according to the length of the space that may be 2T, 3T, 4T, 5T or 6T or more. Or the parameters may be classified more broadly into the three categories according to the length of the space that may be 2T, 3T, or 4T or more. Even so, the write performance can be improved most effectively if each and every mark that is shorter than the limit of optical resolution is recorded with no cooling pulses applied. Also, even in that case, by adjusting the length of a cooling pulse for a recorded mark that is still longer than the limit of optical resolution according to the lengths of the spaces that respectively precede and follow the recorded mark or that of the preceding or following space, a variation in mark length due to thermal interference can be compensated for, and therefore, the write operation can be performed with high density.

In the preferred embodiment described above, write pulse parameters for a 2T mark are supposed to be classified according to the combination of the lengths of its preceding and following spaces. However, the present invention is in no way limited to that specific preferred embodiment. Alternatively, the dTtop and Ttop parameters may also be classified according to only the length of the preceding space. And the dTe parameters may be classified according to only the length of the following space.

Furthermore, in the preferred embodiment described above, the RLL (1, 7) recording code is supposed to be used. However, this is only an example of the present invention. The shortest mark does not always have to be a 2T mark. Also, although the storage density at which the limit of optical resolution is exceeded is represented by a 2T mark in the preferred embodiment described above, the shortest mark does not always have to be a 2T mark because the limit of optical resolution could be exceeded by a 3T or longer mark depending on the storage density required.

Furthermore, in the preferred embodiment described above, the erase power Pe has been described on the supposition that the optical disc loaded is a rewritable information recording medium. However, the present invention is in no way limited to that specific preferred embodiment. Alternatively, the present invention is also applicable to a write-once information recording medium by replacing the erase power Pe with a space power Ps.

Also, in the preferred embodiment described above, the write pulse parameters are supposed to be stored on an information recording medium. However, this is just an example of the present invention. Optionally, the write pulse parameters may also be stored in a memory section of an optical disc drive.

### Embodiment 2

Hereinafter, an optical disc drive as a second preferred embodiment of the present invention will be described.

The optical disc drive of this second preferred embodiment has the same configuration as the optical disc drive 700 shown in FIG. 7. Thus, the optical disc drive of this second preferred embodiment will also be described with reference to FIG. 7 again.

Also, as for the procedure of the processing to be performed by the optical disc drive of the first preferred embodiment described above, the same processing steps to be carried out by the optical disc drive of this preferred embodiment, too, will not be described all over again. The configuration of the optical disc drive 700 of this second preferred embodiment is also shown in FIG. 7.

FIG. 11 illustrates a so-called “N−1 type” write strategy. As an example, a RLL (1, 7) recording code is used to form recorded marks including 2T (that is the shortest one and where T is a channel clock pulse width) through 8T marks and 9T marks for use as a sync pattern to detect a particular timing such as a data starting point. FIG. 11 illustrates the write pulse waveforms of those 2T through 8T marks.

The 2T mark of the N−1 type write strategy shown in FIG. 11 includes a top pulse, which starts at a point in time defined by 2T-dTtop 1106 and which contributes to emitting a laser beam at a peak power Pw (1101) for a period of time defined by 2T-Top 1105, and a cooling pulse, which contributes to emitting a laser beam at a cooling power Pc (1103) from a point in time when the top pulse falls through a point in time when the power rises from the cooling power Pc (1103) to the space power Pe (1102) as defined by 2T-dTs 1107.

The 3T mark of the N−1 type write strategy shown in FIG. 11 includes: a top pulse, which starts at a point in time defined by 3T-dTtop 1109 and which contributes to emitting a laser beam at a peak power Pw (1101) for a period of time defined by 3T-Top 1108; a last pulse, which starts in 2T after NRZI and which contributes to emitting a laser beam at a peak power Pw (1101) for a period of time defined by 3T-Tlp 1110; a bottom pulse, which contributes to emitting a laser beam at a bottom power Pb (1104) from a point in time when the top pulse falls through a point in time when the last pulse rises; and a cooling pulse, which contributes to emitting a laser beam at a cooling power Pc (1103) from a point in time when the last pulse falls through a point in time when the power rises from the cooling power Pc (1103) to the space power Ps (1102) as defined by 3T-dTs 1111.

Speaking more generally, the nT mark (where n is an integer of four through nine) of the N−1 type write strategy shown in FIG. 11 includes: a top pulse, which starts at a point in time defined by nT-dTtop 1113 and which contributes to emitting a laser beam at the peak power Pw (1101) for a period of time defined by nT-Top 1112; multiple pulses, which start synchronously with an NRZI channel clock pulse and which contribute to emitting a laser beam at the peak power Pw (1101) for a period of time defined by Tmp 1116 and at the bottom power Pb (1104) until the laser beam is emitted at the peak power Pw next time from 2T after the NRZI through (n−1)T of NRZI; a last pulse, which starts in (n−1)T after the NRZI and which contributes to emitting a laser beam at the peak power Pw (1101) for a period of time defined by nT-Tlp 1114; and a cooling pulse, which contributes to emitting a laser beam at a cooling power Pc (1103) from a point in time when the last pulse falls through a point in time when the power rises from the cooling power Pc (1103) to the space power Ps (1102) as defined by nT-dTs 1115. It should be noted that the respective parameters of the nT mark could vary according to the n value that falls within the range of four through nine or could remain the same once the n value reaches a certain number.

In the example illustrated in FIG. 11, the bottom power Pb (1104) is supposed to be lower than the cooling power Pc (1103). However, the present invention is in no way limited to that specific preferred embodiment. Alternatively, Pb=Pc or Pb>Pc could be satisfied, too.

FIG. 12 shows examples of pulse width and pulse position parameters for write pulses according to the N−1 type write strategy.

Every parameter representing a pulse width is supposed to have a value that is equal to or greater than zero. On the other hand, each parameter representing a pulse position is supposed to have a positive value in the temporally retrograde direction (i.e., in the direction pointing toward the front edge) as shown in FIGS. 8A through 8C.

The respective top pulse start positions dTtop and respective top pulse widths Ttop of marks with xT lengths are supposed to be classified herein into the parameters of a 2T mark, those of a 3T mark, those of a 4T mark and those of a 5T or longer marks.

Also, the dTtop and Ttop parameters are further classified into the four categories according to the length of the space that precedes each mark and that may be 2T, 3T, 4T or 5T or more. As for a 2T mark, the dTtop and Ttop parameters are further classified into the two categories according to the length of the space that follows the 2T mark and that may be 2T or 3T or more.

The respective cooling pulse end positions dTe of marks with xT lengths are supposed to be classified herein into the parameters of a 2T mark, those of a 3T mark, those of a 4T mark, and those of 5T or longer marks.

The dTe parameters are further classified into the four categories according to the length of the space that follows each mark and that may be 2T, 3T, 4T or 5T or more. As for a 2T mark, the dTe parameters are further classified into the two categories according to the length of the space that precedes the 2T mark and that may be 2T or 3T or more.

The respective last pulse start positions dTlp and respective last pulse widths Tlp of 3T or longer marks with a last pulse are supposed to be classified herein into the parameters of a 3T mark, those of a 4T mark, and those of 5T or longer marks.

Also, the dTip and Tip parameters are further classified into the four categories according to the length of the space that follows each mark and that may be 2T, 3T, 4T or 5T or more.

The multi-pulse width Tmp is a parameter shared in common by every 4T or longer mark with multiple pulses.

In this case, the dTtop, Ttop and dTe parameters of the 2T mark are set so as to satisfy the following Equation (2) with respect to every space that precedes or follows the 2T mark:

1T[ns]−Ttop[ns]+dTtop[ns]−dTe[ns]=0[ns] (2)

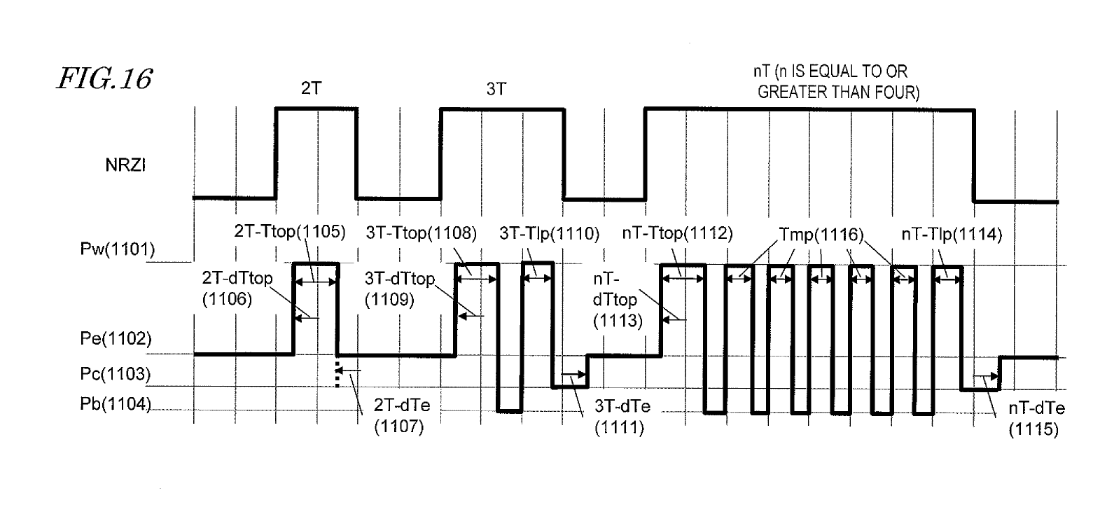

FIG. 15 represents, as an equation using the signs shown in FIG. 12, every possible combination of spaces that respectively precede and follow a 2T mark and that satisfy this Equation (2) on a pattern-by-pattern basis.

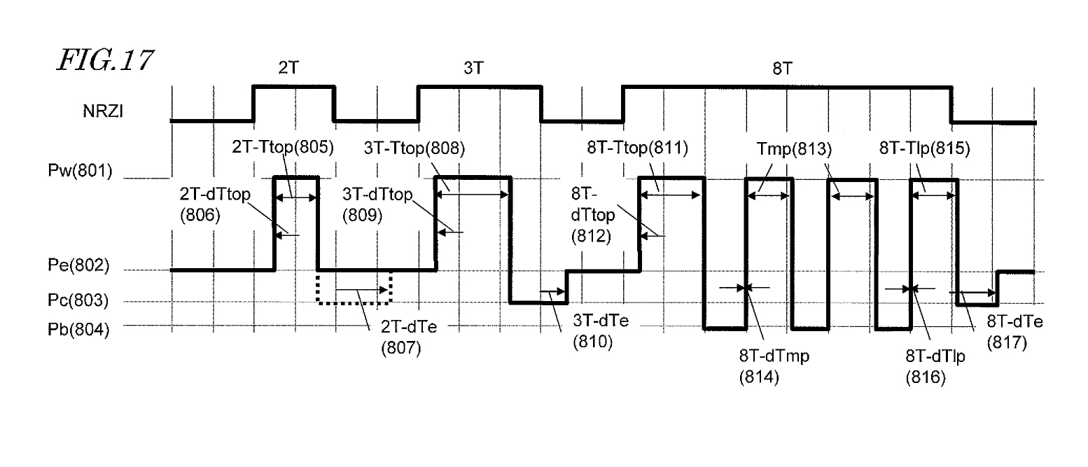

As a result, a 2T write pulse that forms a 2T mark becomes as shown in FIG. 16.

In FIG. 16, the point in time when the top pulse falls as defined by 2T-dTtop 1106 and 2T-Top 1105 agrees with the point in time when the power rises from the cooling power Pc (1103) to the erase power Pe (1102) as defined by 2T-dTe 1107.

Consequently, only the 2T write pulse has no cooling pulse that contributes to emitting a laser beam at the cooling power Pc (1103), and a write operation is performed using only the top pulse. In this preferred embodiment, the cooling pulse conditions for a recorded mark, of which the length is even shorter than the limit of the optical resolution, can be different from those for the other recorded marks as in the first preferred embodiment described above, and therefore, the same effects can also be achieved in this preferred embodiment.

In the preferred embodiment described above, the write pulse parameters are supposed to be classified into the four categories according to the length of a recorded mark that may be 2T, 3T, 4T or 5T or more. However, the present invention is in no way limited to that specific preferred embodiment. Alternatively, the parameters may be classified more finely into the five categories according to the length of the recorded mark that may be 2T, 3T, 4T, 5T or 6T or more. Or the parameters may be classified more broadly into the three categories according to the length of the recorded mark that may be 2T, 3T, or 4T or more. Even so, the write performance can be improved most effectively if each and every mark that is shorter than the limit of optical resolution is recorded with no cooling pulses applied.

Also, in the preferred embodiment described above, the write pulse parameters are supposed to be classified into the four categories according to the length of a space that precedes or follows a recorded mark and that may be 2T, 3T, 4T or 5T or more. However, the present invention is in no way limited to that specific preferred embodiment. Alternatively, the parameters may be classified more finely into the five categories according to the length of the space that may be 2T, 3T, 4T, 5T or 6T or more. Or the parameters may be classified more broadly into the three categories according to the length of the space that may be 2T, 3T, or 4T or more.

Furthermore, in the preferred embodiment described above, write pulse parameters for a 2T mark are supposed to be classified according to the combination of the lengths of its preceding and following spaces. However, the present invention is in no way limited to that specific preferred embodiment. Alternatively, the dTtop and Ttop parameters may also be classified according to only the length of the preceding space. And the dTe parameters may be classified according to only the length of the following space.

Furthermore, in the preferred embodiment described above, the RLL (1, 7) recording code is supposed to be used. However, this is only an example of the present invention. The shortest mark does not always have to be a 2T mark.

Furthermore, in the preferred embodiment described above, the erase power Pe has been described on the supposition that the optical disc loaded is a rewritable information recording medium. However, the present invention is in no way limited to that specific preferred embodiment. Alternatively, the present invention is also applicable to a write-once information recording medium by replacing the erase power Pe with a space power Ps.

Also, in the preferred embodiment described above, the write pulse parameters are supposed to be stored on an information recording medium. However, this is just an example of the present invention. Optionally, the write pulse parameters may also be stored in a memory section of an optical disc drive.

### Embodiment 3

Hereinafter, an optical disc drive as a third preferred embodiment of the present invention will be described.

The optical disc drive of this third preferred embodiment has the same configuration as the optical disc drive 700 shown in FIG. 7. Thus, the optical disc drive of this third preferred embodiment will also be described with reference to FIG. 7 again.

The processing to be performed by the optical disc drive of this preferred embodiment is only partially different from the one performed by the optical disc drive 700 shown in FIG. 7. Thus, the following description will be focused on only their difference. Also, as for the procedure of the processing to be performed by the optical disc drive of the first preferred embodiment described above, the same processing steps to be carried out by the optical disc drive of this preferred embodiment, too, will not be described all over again.

First of all, it will be described how the optical disc drive 700 of this preferred embodiment performs a write operation.

The controller section 707 supplies write data and write pulse parameters to the write pulse generating section 704.

Those write pulse parameters are stored on the information recording medium 701.

The write pulse generating section 704 generates a write signal based on the write data received and write pulse parameters.

The write pulse generating section 704 checks the flag state in each write pulse parameter. When finding that the flag is in OFF state, the write pulse generating section 704 generates a write signal in accordance with the write pulse parameter. On the other hand, when finding the flag is in ON state, the write pulse generating section 704 generates a 2T write pulse shown in FIG. 17 if the write data is 2T and has the polarity in which a mark is recorded.

As can be seen from FIG. 17, if the write data is 2T, a write signal is generated so that the power is not the cooling power Pc (803) but the erase power Pe (802) for a period of time that starts when the 2T top pulse falls and that is defined by 2T-dTe 807.

Then, the write pulse generating section 704 provides the write signal thus generated for the laser control section 703.

On receiving the write signal generated, the laser control section 703 controls the emission pattern of a laser beam from a laser diode built in the optical head section in accordance with the write signal, thereby recording marks on the information recording medium 701. In this manner, data is written.

In the preferred embodiment described above, the N/2 write strategy is supposed to be used as shown in FIG. 17. However, according to the present invention, the N/2 write strategy is not necessarily used. Alternatively, the N−1 type write strategy shown in FIGS. 11 and 12 or the so-called “castle type” write strategy shown in FIGS. 13 and 14 can also be used according to the present invention.

### Embodiment 4

Hereinafter, an information recording medium will be described as a fourth specific preferred embodiment of the present invention.

On the information recording medium of this preferred embodiment, stored are write pulse parameters for the N/2 type write strategy shown in FIG. 9A.

In this case, the dTtop, Ttop and dTe parameters of the 2T mark are set so as to satisfy the following Equation (2) with respect to every space that precedes or follows the 2T mark:

1T[ns]−Ttop[ns]+dTtop[ns]−dTe[ns]=0[ns] (2)

It should be noted that the calculation by this Equation (2) does not always have to be performed on an ns basis. Alternatively, if one step is an amount of time obtained by evenly dividing one T by k (where k is an integer) and if the pulse width, pulse position or every other parameter is represented by the number of steps, then Equation (2) may be modified into the following Equation (3):

K[step]−Ttop[step]+dTtop[step]−dTe[step]=0[step] (3)

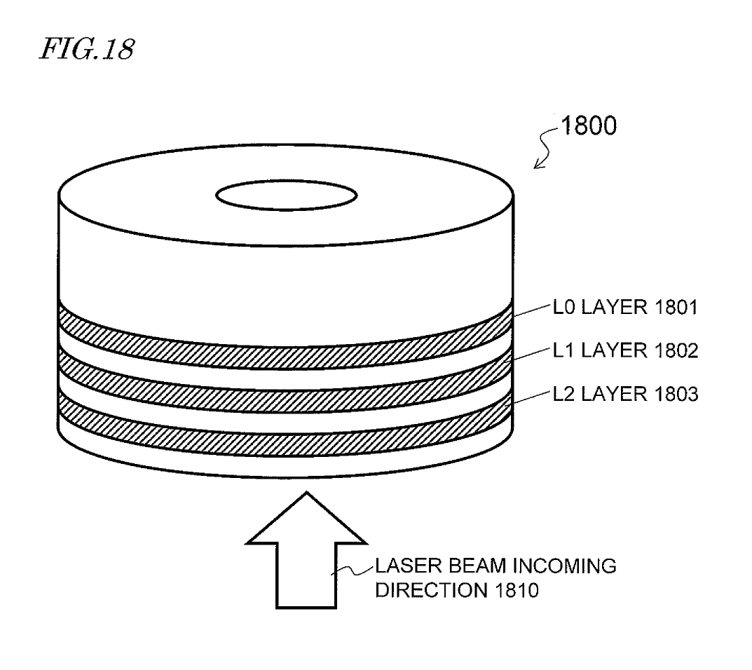

Next, a multilayer optical disc will be described as an example of an information recording medium according to a preferred embodiment of the present invention. FIG. 18 illustrates an information recording medium 1800 with three recording layers as an exemplary information recording medium according to a preferred embodiment of the present invention. Supposing the recording layer that is located at the deepest level in the laser beam incoming direction 1810 is the L0 layer 1801, the other L1 and L2 layers 1802 and 1803 are arranged in the laser beam incoming direction so as to get closer to the light source of the laser beam in this order.

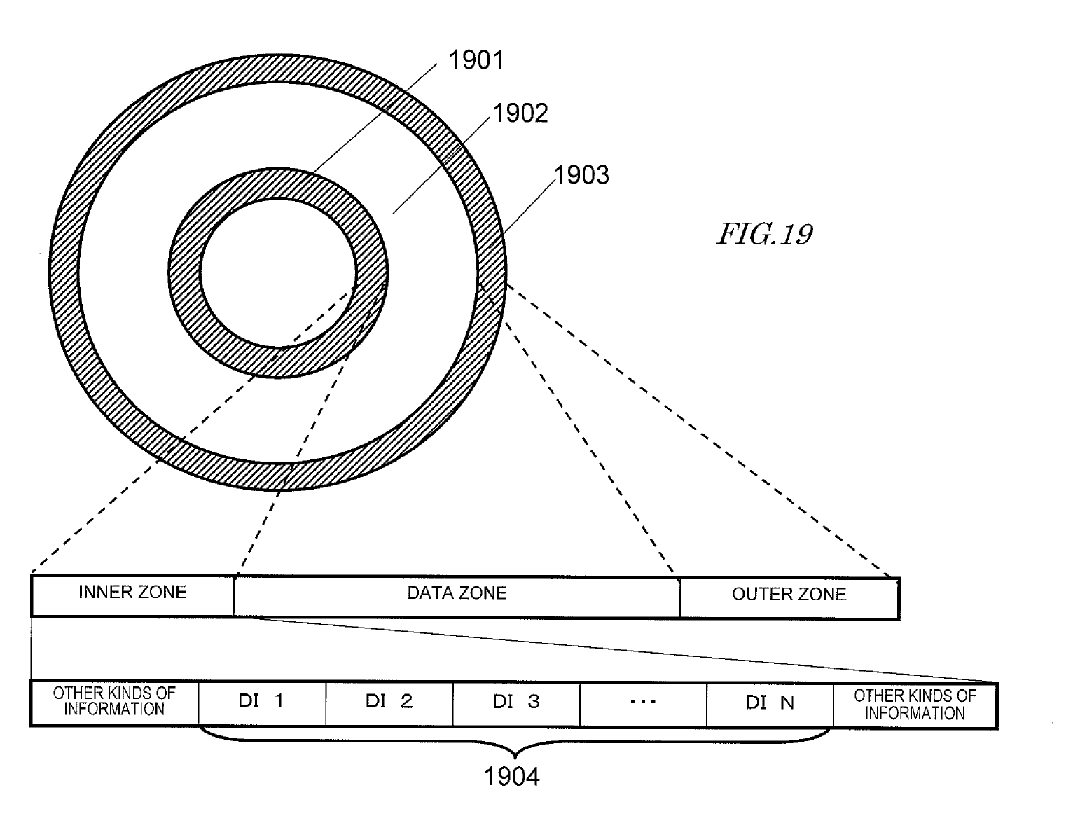

FIG. 19 illustrates the planar layout of multiple zones on at least one of the recording layers of the information recording medium. As shown in FIG. 19, an inner zone 1901, a data zone 1902 and an outer zone 1903 are arranged in this order from the inner edge of the information recording medium toward its outer edge. In a disc management information area 1904 in the inner zone 1901, stored is disc management information that is called “disc information (DI)”. The write pulse parameters are included in that DI. And that disc management information is stored in advance on a medium during its manufacturing process. In the triple-layer information recording medium shown in FIG. 18, for example, the disc management information is stored on at least its L0 layer 1801. Then, just by scanning the DI area of the L0 layer 1801, the optical disc drive can retrieve at a time the disc management information of every recording layer L0, L1, and L2, thus getting the disc loading process done in a shorter time. Although the preferred embodiment described above is supposed to be applied to a triple-layer information recording medium, this is only an example of the present invention. Alternatively, the present invention is also applicable to a single- or double-layer information recording medium or even an information recording medium with four or more recording layers. For example, an n-layer information recording medium (where n is an integer that is equal to or greater than one) has n recording layers L0, L1, . . . and Ln−1 and the disc management information just needs to be stored in at least one of those n recording layers.

It should be noted that the write strategy of this preferred embodiment is applicable to any recording layer of the given information recording medium. And the write strategy of this preferred embodiment satisfies Equations (2) and (3). In that case, the 2T write pulse will have no cooling power as shown in FIG. 10. Since there is no cooling power, the heat-dissipation property of the target recording layer needs to be considered when a mark is going to be recorded thereon. Speaking of the heat dissipation property, if the write strategy of this preferred embodiment is applied to the L0 layer 1801 of the triple-layer information recording medium shown in FIG. 18, for example, a film that determines the heat-dissipation property of the L0 layer can be thickened with no attention paid to the transmission of the light because there is no recording layer on the other side of the L0 layer opposite to its laser beam incident side. Thus, it is relatively easy to improve the heat-dissipation property of the L0 layer and the effect of the present invention should be achieved particularly significantly on that L0 layer. Likewise, as long as sufficient heat dissipation is ensured, the effect of the present invention should be achieved on not just the L0 layer but also any other recording layer as well. In the preferred embodiment described above, the present invention is supposed to be applied to a triple-layer information recording medium. However, this is just an example of the present invention and this invention is also applicable to a single- or double-layer information recording medium or an information recording medium with four or more recording layers as well.

In the preferred embodiment described above, the write pulse parameters are supposed to be classified into the four categories according to the length of a recorded mark that may be 2T, 3T, 4T or longer even-numbered T, or 5T or longer odd-numbered T. However, the present invention is in no way limited to that specific preferred embodiment. Alternatively, the parameters may also be classified more finely into the five categories according to the length of the recorded mark that may be 2T, 3T, 4T, 5T or longer odd-numbered T, 6T or longer even-numbered T. Or the parameters may be classified even more finely into the six categories according to the length of the recorded mark that may be 2T, 3T, 4T, 5T, 6T or longer even-numbered T, or 7T or longer odd-numbered T.

Also, in the preferred embodiment described above, the N/2 type write strategy is supposed to be used. However, according to the present invention, the N/2 type write strategy does not have to be used. The present invention is also applicable to the N−1 type write strategy shown in FIGS. 11 and 12 and to the so-called “castle type” write strategy shown in FIGS. 13 and 14.

Also, in the preferred embodiment described above, the write pulse parameters are supposed to be classified into the four categories according to the length of a space that precedes or follows a recorded mark and that may be 2T, 3T, 4T or 5T or more. However, the present invention is in no way limited to that specific preferred embodiment. Alternatively, the parameters may be classified more finely into the five categories according to the length of the space that may be 2T, 3T, 4T, 5T or 6T or more. Or the parameters may be classified more broadly into the three categories according to the length of the space that may be 2T, 3T, or 4T or more.

Furthermore, in the preferred embodiment described above, write pulse parameters for a 2T mark are supposed to be classified according to the combination of the lengths of its preceding and following spaces. However, the present invention is in no way limited to that specific preferred embodiment. Alternatively, the dTtop and Tstop parameters may also be classified according to only the length of the preceding space. And the dTe parameters may be classified according to only the length of the following space.

### INDUSTRIAL APPLICABILITY

The present invention is applicable particularly effectively to the field of technology for getting high-density writing done on information recording media. That is to say, according to the present invention, a write operation can be performed at an even better SNR on an information recording medium with an increased density and a read operation can be performed on it at a reduced error rate. Thus, the present invention contributes greatly to realizing a high-density information recording medium.

### REFERENCE SIGNS LIST

700 optical disc drive
701 information recording medium
702 optical head section
703 laser control section
704 write pulse generating section
705 read signal processing section
706 data processing section
707 controller section
708 memory section

1. A method for writing a data sequence as a combination of marks and spaces on an information recording medium by condensing a laser beam through a lens,
wherein a cooling pulse for recording a mark that is even shorter than the limit of optical resolution of the laser beam and another cooling pulse for recording a mark that is still longer than the limit of the optical resolution of the laser beam are applied under mutually different conditions, and
wherein if a mark length is P, the wavelength of the laser beam is λ and the numerical aperture of the lens is NA,
the mark that is shorter than the limit of the optical resolution of the laser beam satisfies P≦λ/4NA, and
the mark that is still longer than the limit of the optical resolution of the laser beam satisfies P>λ/4NA, and
wherein the width of the cooling pulse for recording the mark that satisfies P≦λ/4NA is set to be equal to zero, and
wherein the width of the cooling pulse for recording the mark that satisfies P>λ/4NA is set to be not equal to zero.

2.-3. (canceled)

4. The writing method of claim 1, wherein when the mark that satisfies P≦λ/4NA is recorded, the width of the cooling pulse is always set to be equal to zero, irrespective of the lengths of the two spaces that respectively precede and follow the mark, and
wherein when the mark that satisfies P>λ/4NA is recorded, the width of the cooling pulse is set to be not equal to zero according to the length of at least one of the two spaces that respectively precede and follow the mark.

5. A device for writing a data sequence as a combination of marks and spaces on an information recording medium, the device comprising an optical head section including a lens that condenses a laser beam and a control section for controlling the pulse shape of a write signal,
wherein the control section makes a condition for applying a cooling pulse to record a mark that is even shorter than the limit of optical resolution of the laser beam different from a condition for applying another cooling pulse to record a mark that is still longer than the limit of the optical resolution of the laser beam, and
wherein if a mark length is P, the wavelength of the laser beam is λ and the numerical aperture of the lens is NA,
the mark that is shorter than the limit of the optical resolution of the laser beam satisfies P≦λ/4NA, and
the mark that is still longer than the limit of the optical resolution of the laser beam satisfies P>λ/4NA, and
wherein the control section sets the width of the cooling pulse for recording the mark that satisfies P≦λ/4NA to be equal to zero, and also sets the width of the cooling pulse for recording the mark that satisfies P>λ/4NA to be not equal to zero.

6.-7. (canceled)

8. The writing device of claim 5, wherein when the mark that satisfies P≦λ/4NA is recorded, the control section always sets the width of the cooling pulse to be equal to zero, irrespective of the lengths of the two spaces that respectively precede and follow the mark, and
wherein when the mark that satisfies P≧λ/4NA is recorded, the control section sets the width of the cooling pulse to be not equal to zero according to the length of at least one of the two spaces that respectively precede and follow the mark.

9. An information recording medium on which a data sequence is written as a combination of marks and spaces by being irradiated with a laser beam that has been condensed through a lens,
wherein the recording medium has a disc information area on which stored is a writing condition that is defined so that a cooling pulse for recording a mark that is even shorter than the limit of optical resolution of the laser beam and another cooling pulse for recording a mark that is still longer than the limit of the optical resolution of the laser beam are applied under mutually different conditions, and
wherein if a mark length is P, the wavelength of the laser beam is λ and the numerical aperture of the lens is NA,
the mark that is shorter than the limit of the optical resolution of the laser beam satisfies P≦λ/4NA, and
the mark that is still longer than the limit of the optical resolution of the laser beam satisfies P>λ/4NA, and wherein the writing condition is defined so that the width of the cooling pulse for recording the mark that satisfies P≦λ/4NA is set to be equal to zero and that the width of the cooling pulse for recording the mark that satisfies P>λ/4NA is set to be not equal to zero.

10. The information recording medium of claim 9, wherein the writing condition stored on the disc information area is defined so that when the mark that satisfies P>λ/4NA is recorded, the width of the cooling pulse is always set to be equal to zero, irrespective of the lengths of the two spaces that respectively precede and follow the mark and that when the mark that satisfies P>λ/4NA is recorded, the width of the cooling pulse is set to be not equal to zero according to the length of at least one of the two spaces that respectively precede and follow the mark.
